(19) United States
(12) Patent Application Publication
(10) Pub. No.: US 2026/0348805 A1
(43) Pub. Date: Nov. 5, 2026

(54) DUAL-STAGE PREWARMING FOR PATHOGEN ENRICHMENT

(71) Applicant: pathOtrak Inc., College Park, MD (US)

(72) Inventor: Javier Atencia, College Park, MD (US)

(21) Appl. No.: 19/665,607

(22) Filed: May 1, 2026

Related U.S. Application Data
(60) Provisional application No. 63/799,182, filed on May 2, 2025.

(51) Int. Cl. G01N 1/44

(52) U.S. Cl. CPC G01N 1/44

(57) ABSTRACT

Examples relate to preparing a sample of consumable product for pathogen detection. A first temperature of the sample is measured at an arrival temperature within a range of 0° C. to 25° C., independent of any prior refrigeration of the sample. The sample is brought, independently of any enrichment medium, to a second temperature in a range of 20° C. to 37° C. An enrichment medium is actively prewarmed to a third temperature in a range of 35° C. to 45° C. After the sample reaches the second temperature, the sample is combined with the actively prewarmed enrichment medium at a ratio within a range of 1:1 to 1:6 g/mL to form a sample-enrichment medium mixture. The mixture is incubated within a fluid-sealed incubation chamber at an ambient temperature within a range of 35° C. to 42° C. The second and third temperatures are selected such that the mixture reaches, within ±2° C., a target thermal equilibrium within 30 minutes after combining.

### CLAIM OF PRIORITY

This application claims priority to and the benefit of U.S. Provisional Application Ser. No. 63/799,182, filed May 2, 2025, which is hereby incorporated herein by reference, and the benefit of the priority of which is claimed herein.

### BACKGROUND

Food safety testing can involve examination of consumable products, including produce, meats, poultry, seafood, dairy, and processed foods, for the presence of microbial contaminants. Regulatory frameworks administered by agencies such as the United States Food and Drug Administration (FDA) and similar international bodies set forth sampling, handling, and testing protocols that food producers, distributors, and laboratories follow prior to product release into commerce.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 is a schematic block diagram of an example of a sample preparation system 100.

FIG. 2 is a flowchart of an example of a sample preparation method 200.

FIG. 3 is a block diagram of an example of a prewarming control architecture 300.

FIG. 4 is a graph of an example of a thermal convergence profile 400.

FIG. 5 illustrates a cross-sectional view of an example of a multimodal prewarming apparatus 500.

FIG. 6 is a flowchart illustrating a process of preparing a sample of consumable product for pathogen detection, according to some examples.

FIG. 7 is a block diagram of a machine.

### DETAILED DESCRIPTION

Detection of foodborne pathogens by enrichment-based assays is sensitive to the thermal history of the sample. One approach laid out in U.S. Pat. No. 12,287,315 addresses cold-stress-induced lag-phase extension by avoiding refrigeration entirely—obtaining the sample at or near harvest, prior to any chilling, and applying a thin micro-layer of enrichment medium to the non-chilled sample. This approach assumes a controlled supply chain in which the sample never experiences cold stress between harvest and the laboratory.

In practice, this assumption does not hold in commercial produce-testing workflows. Samples taken at harvest are exposed to wide ambient swings—daytime temperatures of 20° C. or higher during transport, overnight temperatures that may approach or fall below 0° C. in production regions such as the Salinas Valley—and to uncontrolled holding conditions on trucks and at receiving docks. As a result, samples frequently arrive at the testing laboratory at temperatures that are neither reliably chilled nor reliably non-chilled, and the cold-stress condition the prior art seeks to avoid is, in fact, often present regardless of the operator's intent. The prior art's premise is therefore inapplicable to a substantial fraction of real-world testing.

The present inventors have observed that, for samples whose arrival temperature is variable and uncontrolled, the dominant determinant of enrichment lag-phase duration is not whether the sample was previously chilled, but the time required for the sample-enrichment medium mixture to reach the target enrichment temperature. Reducing that equilibration time below approximately 30 minutes, and bringing the mixture to within ±2° C. of the target, substantially compresses the lag phase regardless of the sample's prior thermal history. The techniques disclosed herein are accordingly agnostic to whether the sample arrives chilled, at ambient temperature, or warmed, and rely on active thermal management of both the sample and the enrichment medium to drive a rapid, controlled approach to a defined incubation equilibrium.

A further aspect of the techniques disclosed herein is the order in which thermal energy is delivered. Combining a cold sample with prewarmed enrichment medium first, and then placing the combined mixture in an incubator, requires the incubator to drive the entire combined thermal mass—sample plus medium—toward the target temperature. By contrast, prewarming the sample alone, independently of the enrichment medium, presents a smaller thermal mass to the heat source and permits the sample to be brought to the second temperature more rapidly. Combining the warmed sample with separately-prewarmed medium then yields a mixture already close to the target equilibrium, rather than a mixture that must subsequently be driven to it. This sequencing—separate prewarming of sample and medium, followed by combination—contributes materially to the achievement of the target equilibrium within the recited 30-minute window.

This document relates to preparation of samples of consumable products for pathogen detection. Generally, food safety testing can involve a portion of a consumable product being prepared with a liquid nutrient formulation. The resulting combination can be held under certain temperature-controlled conditions, selected such that they support the growth of one or more target microorganisms. After a period of incubation, the combined material can be analyzed using nucleic-acid-based assays, immunochemical assays, culture-based plating, or other analytical techniques to determine whether target pathogens are present. The reliability of the analytical result can depend on whether the target microorganisms reached detectable levels during the enrichment period. In an example, one or more samples of a consumable product can be collected at one location and transported to a separate testing facility. During transit, a sample can be held under refrigerated conditions, e.g., to preserve the integrity of the matrix and to limit the proliferation of non-target microflora. Such delivery involving refrigeration can cause certain samples to arrive at the testing facility at a temperature well below a temperature range that best supports the growth of certain target pathogens. Generally, the sample must be transitioned from refrigerated conditions to conditions that support enrichment.

The rate at which this transition occurs can influence the overall time required to obtain a test result. Such a rate of thermal transition can depend on sample volume (larger sample volumes can, e.g., carry more thermal mass than smaller sample volumes). Further, heat transfer from the exterior of a sample to the interior of the sample is governed by the thermal conductivity of the matrix, the geometry of the sample, and the temperature gradient. For sample portions on the order of one kilogram or more, the time for the interior of the sample to reach a target temperature can be substantially longer than the time for the exterior of the sample to reach the same target temperature. Non-uniform temperature distributions within the sample during the transition may cause different portions of the sample to support microbial growth at different rates.

One approach to the thermal transition can involve combining a refrigerated sample with a larger volume of heated enrichment medium. Here, the heat content of the medium alone can be used to raise the overall temperature of the combined material. The ratio of medium to sample under this approach can be substantial and can produce a combined volume that consumes space within the incubation equipment. Such an approach can increase the consumption of medium, and in certain circumstances can increase the volume of biohazardous waste generated at the end of the test. In addition, the temperature at which the medium is applied can be limited by the thermal tolerance of the target microorganisms, so often it may be impractical to simply heat the medium to any suitable temperature for offsetting an especially cold sample.

A similar approach to the thermal transition can involve diluting the sample with a relatively larger volume of medium at a more moderate temperature. This approach can reduce the risk of thermal damage to microorganisms but can also dilute any target microorganisms present in the sample, which can complicate organism detection. Dilution can also extend the time needed for the target microorganisms to reach detectable levels during enrichment, as a greater number of doubling cycles can be required within a larger total volume.

More generally, the sample of consumable product can arrive at the pre-warming chamber 102 across a range of arrival temperatures, including without limitation an arrival temperature within a range of 0° C. to 25° C. The arrival temperature is independent of any prior refrigeration of the sample; the methods and systems described herein operate without reliance on a controlled cold chain between collection of the sample and its receipt at the pre-warming chamber 102. By way of non-limiting example, the sample may arrive within a range of 0° C. to 10° C. (e.g., where the sample has been refrigerated during transit), at or above 15° C. (e.g., where ambient transport temperatures during daytime hours have warmed the sample), or at intermediate temperatures reflecting uncontrolled ambient exposure during transit and holding. The dual-stage prewarming approach disclosed herein is accordingly applicable to samples whose thermal history between collection and receipt is not controlled, and the second and third temperatures applied to the sample and the enrichment medium, respectively, can be selected to drive the sample-enrichment medium mixture to the target thermal equilibrium regardless of the sample's arrival temperature within the foregoing range.

The present inventors have recognized the benefits of a technique for preparing a sample of consumable product for pathogen detection, involving a workflow for conditioning the sample and the enrichment medium along independent thermal paths prior to their combination. For example, the sample can be conditioned, in the absence of any enrichment medium, toward a first target temperature range. The enrichment medium can be conditioned along a separate path toward a second target temperature range. The two conditioned components can then be combined at a defined ratio such as to form a sample-enrichment medium mixture, and the mixture can be held within an incubation chamber under temperature-controlled conditions that support microbial growth.

An exemplary sample preparation system can include a sample receiving unit that accepts a sample having been held under refrigerated conditions. Optionally, the system can include or use a temperature sensor to measure a temperature associated with the sample at a time point prior to conditioning. A prewarming unit can facilitate bringing the sample toward a defined temperature range. The prewarming unit may operate by active heating, by passive heating via the ambient environment, or a combination thereof. Active heating can involve forced-air convection, infrared radiation, microwave radiation, conductive heating, or a combination thereof. Passive heating can, e.g., include exposure of the sample to a gas headspace of an environment surrounding the prewarming unit. An enrichment medium reservoir can hold a volume of enrichment medium and can condition that volume toward a separate defined temperature range. In an example, the conditioned medium can be transferred from the reservoir toward a location at which the conditioned medium is combined with the conditioned sample. Optionally, a mixer or homogenizer can be included or used in the system to combine the two conditioned components. Finally, an incubation chamber can hold the combined material at a temperature and for a duration that support microbial growth. In an example, the system can include or use controller circuitry configured for coordinating the operation of one or more of the prewarming unit, the enrichment medium reservoir, the dispensing assembly, the mixer, or the incubation chamber. The controller circuitry can, e.g., receive feedback signals from one or more temperature sensors thermally associated with the sample, the medium, or both, and can control the output of one or more heating elements such as to regulate the temperature toward a defined setpoint. In an example, the controller circuitry can execute a proportional-integral-derivative control loop to perform such regulation. The controller circuitry can also receive input representing the mass of the sample and may cooperate with a power monitor to track the energy applied during the conditioning of the sample.

As compared with certain other approaches for thermal transition, techniques for conditioning the sample and the medium along independent thermal paths prior to combination can reduce the volume of medium required to bring the combined material to a temperature range that supports microbial growth. Examples described herein can also reduce the time required for the combined material to reach that temperature range after combination. In an example, the combined material can reach the target temperature range within a defined convergence window following combination, independent of the thermal history of the sample prior to arrival at the testing facility.

Examples described herein can be applied across a range of consumable product types and sample sizes. Solid food matrices, including leafy greens, meats, poultry, seafood, and composite samples, as well as liquid food products and beverage samples, can be processed using the systems and processes. Examples described herein can also operate in cooperation with certain downstream analytical techniques, including concentration steps such as filtration, centrifugation, and affinity-based capture, and detection modalities such as nucleic-acid based assays, immunochemical assays, and culture-based plating.

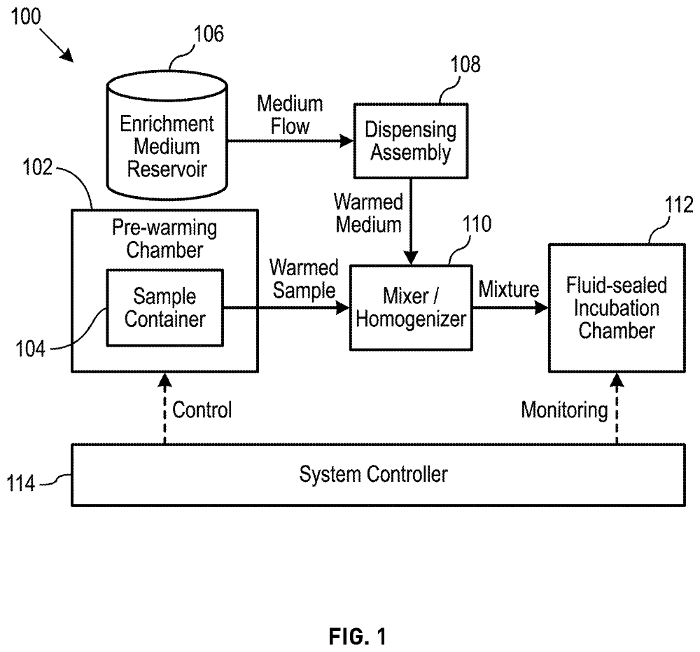

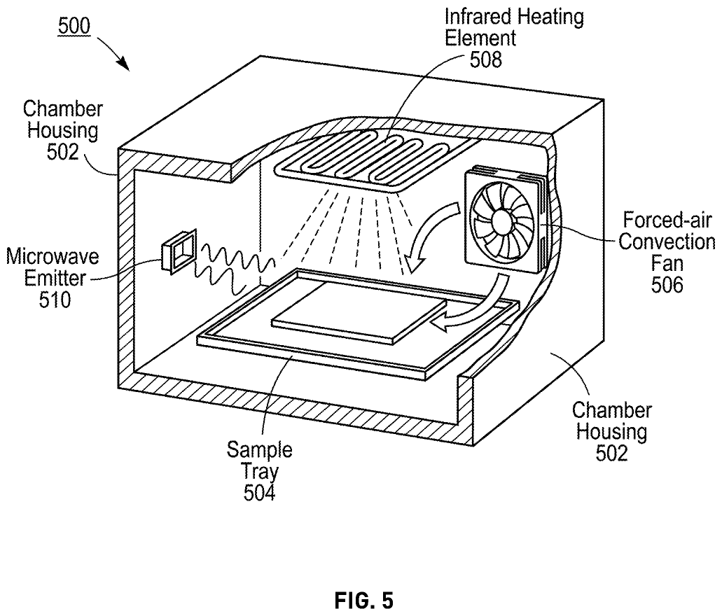

FIG. 1 is a schematic block diagram of an example of a sample preparation system 100. In an example, the system 100 includes a pre-warming chamber 102 containing a sample container 104, an enrichment medium reservoir 106, a dispensing assembly 108, a mixer/homogenizer 110, a fluid-sealed incubation chamber 112, and a system controller 114. The pre-warming chamber 102 can be arranged such as to condition a sample of consumable product, independently of any enrichment medium, toward a target temperature. In some examples, the pre-warming chamber 102 can be arranged to bring the sample toward a second temperature within a range of about 20° C. to about 37° C., where the sample has been received following refrigeration at a first temperature less than about 8° C. Herein, the first temperature (of refrigeration) refers to an ambient air temperature within a cooling container (e.g., a cooler, refrigerator, etc.) and does not necessarily refer to a temperature that the consumable product therein has reached (e.g., following transit or storage). In an example, the pre-warming chamber 102 can be implemented as a forced-air convection chamber, a water bath, a radiant chamber, or any other structure capable of transferring thermal energy to the sample, and can include one or more heating modalities described further with reference to FIG. 5.

The sample container 104 can reside within the pre-warming chamber 102 and holds the sample of consumable product during conditioning. In some examples, the sample container 104 is a vessel sized to accommodate a solid food matrix on the order of one kilogram or more, such as leafy greens, meats, or poultry. The sample container 104 can also be configured to accommodate a liquid food or beverage sample. While depicted in FIG. 1 as discrete elements, in certain examples the sample container 104 itself defines the pre-warming chamber 102, or the pre-warming chamber 102 can itself directly and solely house the sample. For example, the sample container 104 can be used as the pre-warming chamber 102 for passive prewarming of the sample of consumable product, such as by placing the sample in the sample container 104 for a period (e.g., within a range of about 6 hours to about 18 hours, such as about 12 hours), such as via exposing the sample to an ambient temperature surrounding the sample container 104 after removing the sample from a refrigerated environment.

The enrichment medium reservoir 106 can be configured to hold a volume of enrichment medium and to actively prewarm the medium toward a third temperature. In some examples, the enrichment medium reservoir 106 is configured to prewarm the medium to a third temperature within a range of about 35° C. to about 45° C. The enrichment medium reservoir 106 can contain media such as buffered peptone water, Rappaport-Vassiliadis soy peptone broth, tetrathionate broth, selenite cystine broth, Fraser broth, modified tryptone soya broth, Bolton broth, Preston broth, or any other nutrient formulation compatible with the target microorganism. In an example, the system 100 can include or use a dispensing assembly 108, which can be coupled to the enrichment medium reservoir 106 via a medium flow path. For example, the dispensing assembly 108 can be arranged to transfer the prewarmed medium from the reservoir 106 toward the mixer/homogenizer 110 at a controlled volumetric rate. Here, the dispensing assembly 108 can be controlled (e.g., via controller circuitry) such that it delivers the medium after the sample reaches the second temperature. In an example, such delivery via the dispensing assembly 108 can facilitate a combining of the warmed sample and the warmed medium, such as to produce a sample-enrichment medium mixture at a ratio within a range of 1:1 to 1:6 grams of sample per milliliter of medium.

In an example, the system 100 can include or use a mixer/homogenizer 110, arranged to receive the warmed sample from the sample container 104 and the warmed medium from the dispensing assembly 108. The mixer/homogenizer 110 can be configured to combine and homogenize the warmed sample and the warmed medium to form the sample-enrichment medium mixture. In an example, the mixer/homogenizer 110 can include a paddle blender, a rotary agitator, or a stomacher-type device. The combined mixture can then be conveyed from the mixer/homogenizer 110 toward the fluid-sealed incubation chamber 112.

The fluid-sealed incubation chamber 112 can be sized and shaped such as to hold the sample-enrichment medium mixture under controlled environmental conditions (e.g., fluidly isolated from an ambient environment surrounding the incubation chamber 112) during an incubation period. In some examples, the fluid-sealed incubation chamber 112 can maintain an ambient temperature within a range of 35° C. to 42° C. The sealed nature of the chamber 112 can reduce evaporative loss, limit exposure to ambient microflora, and maintain a uniform thermal boundary around the mixture during incubation.

In an example, the second temperature applied by the pre-warming chamber 102 and the third temperature applied by the enrichment medium reservoir 106 can each be selected such that the sample-enrichment medium mixture within the chamber 112 reaches, within ±2 ° C., a target thermal equilibrium in a range of 35° C. to 42° C. within 30 minutes after the warmed sample and the warmed medium are combined. The combination of independent thermal paths for the sample and the medium, together with the defined mixing ratio, can facilitate that the target thermal equilibrium is reached, such as using a reduced volume of enrichment medium relative to certain other approaches that rely solely on heated medium to bring a refrigerated sample to temperature. For example, while certain other workflows involve diluting a sample of about 1,500 grams (g) with approximately about 4,500 milliliters (mL) of heated medium and yield a mixture below 30° C. for an extended interval, the system 100 can instead, e.g., yield a mixture within the target thermal equilibrium range using on the order of about 2,000 mL of medium for a comparably sized sample.

In some examples, the second temperature and the third temperature can be selected such that the sample-enrichment medium mixture reaches the target thermal equilibrium within 15 minutes after the sample is combined with the actively prewarmed enrichment medium. A reduced equilibration window of this kind can be achieved, for example, by selecting the second temperature toward an upper portion of the recited 20° C. to 37° C. range, by selecting the third temperature toward an upper portion of the recited 35° C. to 45° C. range, by selecting a sample-to-medium ratio toward a higher proportion of medium within the recited 1:1 to 1:6 g/mL range, or by a combination of the foregoing.

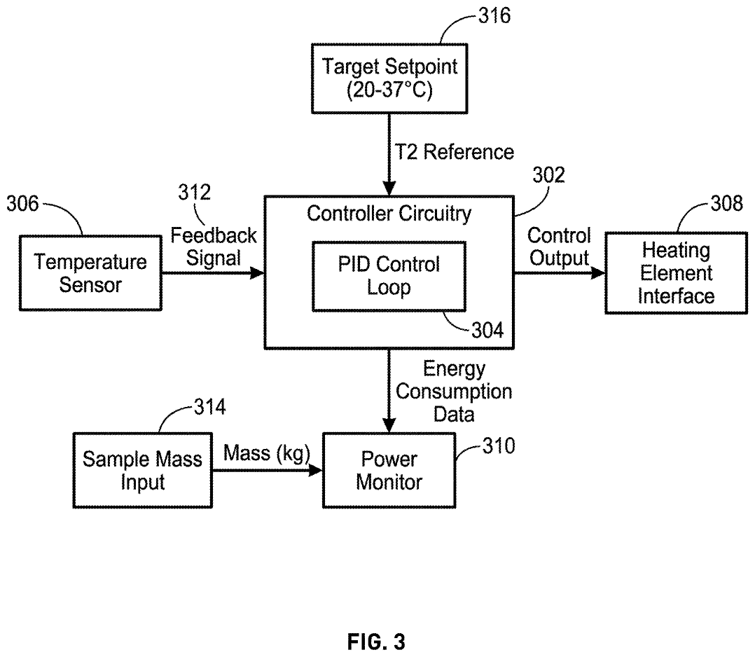

The system controller 114 can be operatively coupled to the pre-warming chamber 102, the dispensing assembly 108, the mixer/homogenizer 110, and the fluid-sealed incubation chamber 112 via control and monitoring paths. The system controller 114 can be configured to issue control signals to the pre-warming chamber 102 to regulate application of heat to the sample, to the dispensing assembly 108 to trigger transfer of the prewarmed medium after the sample reaches the second temperature, to the mixer/homogenizer 110 to initiate homogenization, and to the incubation chamber 112 to maintain ambient conditions during incubation. In an example, the system controller 114 can be arranged such that it receives feedback signals indicative of temperature, mass, or energy consumption associated with one or more of the foregoing components, and to modulate its control outputs based on such feedback. Details of the control circuitry associated with the system controller 114 are described further with reference to FIG. 3.

The system 100 can be deployed in a variety of operational environments. In some examples, the system 100 can be deployed at a centralized testing laboratory that receives refrigerated samples from geographically distributed growers or processors. In another example, the system 100 can be deployed at or near the point of harvest, slaughter, or processing, such that samples enter the pre-warming chamber 102 shortly after collection. The system 100 may also be implemented in certain mobile configurations, including vehicle-mounted units that accompany sampling crews in the field, to reduce the time between sample collection and initiation of the conditioning workflow.

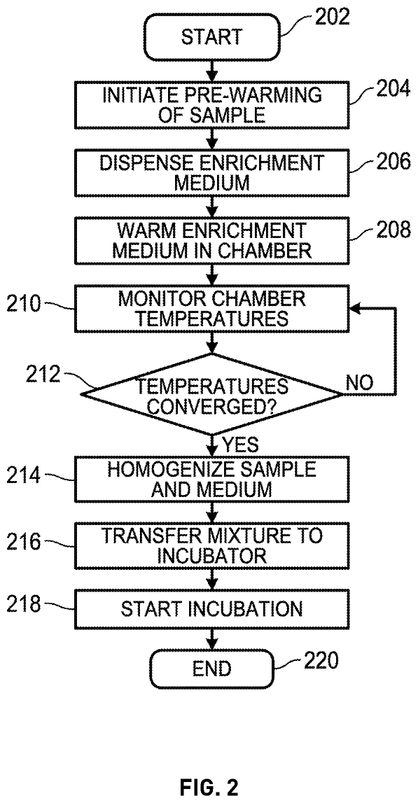

FIG. 2 is a flowchart of a sample preparation process 200, according to some examples. To illustrate certain aspects, operations of the process 200 are described with reference to the sample preparation system 100 of FIG. 1.

The process 200 begins at a start state 202 and proceeds through a sequence of operations that coordinate independent thermal conditioning of a sample of consumable product and an enrichment medium, followed by combination and incubation of the resulting sample-enrichment medium mixture. Although described in a particular sequence, one or more operations of the process 200 may be performed in parallel, as discussed further below.

At operation 204, the process 200 initiates pre-warming of the sample. In some examples, the system controller 114 issues a control signal to the pre-warming chamber 102 of FIG. 1 to begin applying thermal energy to the sample of consumable product held within the sample container 104. The sample may have been received at an arrival temperature within a range of 0° C. to 25° C., the arrival temperature being independent of any prior refrigeration of the sample (e.g., on the order of 8° C. in some examples, at or above 15° C. in others), and a first temperature of the sample may be measured prior to operation 204 by a temperature sensor thermally associated with the sample container 104. The pre-warming chamber 102 can bring the sample, independently of any enrichment medium, toward a second temperature in a range of 20° C. to 37° C.

Following initiation of sample pre-warming, the process 200 proceeds to operation 206. At operation 206, the dispensing assembly 108 of FIG. 1 dispenses enrichment medium from the enrichment medium reservoir 106 into a conditioning volume. In some examples, the enrichment medium includes buffered peptone water, modified tryptone soya broth, Fraser broth, or another nutrient formulation compatible with a target microorganism. The dispensing operation at 206 may occur in parallel with the pre-warming operation at 204, such that both the sample and the medium are conditioned along independent thermal paths concurrently.

The process 200 then proceeds to operation 208, at which the enrichment medium is warmed in a chamber. The enrichment medium reservoir 106, or a separate warming chamber coupled to the reservoir 106, can actively prewarm the medium toward a third temperature in a range of 35° C. to 45° C. Active prewarming at operation 208 may be implemented via forced-air convection, conductive heating through the reservoir walls, in-line resistive heating along the medium flow path, or combinations thereof.

At operation 210, the process 200 monitors chamber temperatures. In some examples, the system controller 114 receives feedback signals from one or more temperature sensors thermally associated with the pre-warming chamber 102 and the enrichment medium reservoir 106. The feedback signals may represent the current temperature of the sample, the current temperature of the medium, ambient chamber temperature, or a combination thereof. The system controller 114 can sample the feedback signals at a defined polling interval to produce a running record of the thermal state of each conditioning path.

Following the monitoring operation at 210, the process 200 proceeds to a decision state 212, at which the process 200 evaluates whether the temperatures have converged. Specifically, the system controller 114 may compare the current sample temperature against a defined second-temperature band (e.g., 20° C. to 37° C.) and the current medium temperature against a defined third-temperature band (e.g., 35° C. to 45° C.). If either temperature remains outside of its respective band, the process 200 returns along the NO branch to operation 210 and continues to monitor the chamber temperatures. In response to both temperatures reaching their respective bands, the process 200 advances along the YES branch to operation 214.

At operation 214, the mixer/homogenizer 110 of FIG. 1 homogenizes the sample and the medium. The system controller 114 may trigger the dispensing assembly 108 to transfer the prewarmed medium from the reservoir 106 to the mixer/homogenizer 110, where the prewarmed medium is combined with the warmed sample from the sample container 104 at a ratio within a range of 1:1 to 1:6 grams of sample per milliliter of medium, to form a sample-enrichment medium mixture. The mixer/homogenizer 110 can apply mechanical agitation, paddle-blending, or stomacher-type action to produce a substantially uniform distribution of medium across the surfaces and interstitial regions of the sample matrix.

The process 200 proceeds to operation 216, at which the mixture is transferred to an incubator. Specifically, the sample-enrichment medium mixture is conveyed from the mixer/homogenizer 110 to the fluid-sealed incubation chamber 112 of FIG. 1. Transfer at operation 216 may be performed by a peristaltic pump, a gravity-fed conduit, or manual transfer of a sealed vessel, depending on the deployment configuration.

Upon transfer, the process 200 proceeds to operation 218, at which incubation is started. The fluid-sealed incubation chamber 112 is configured to hold the sample-enrichment medium mixture at an ambient temperature within a range of 35° C. to 42° C. for a defined incubation duration that supports proliferation of a target microorganism. In some examples, the second temperature applied at operation 204 and the third temperature applied at operation 208 are each selected such that, upon combination at operation 214 and transfer at operation 216, the mixture reaches a target thermal equilibrium within ±2° C. of a value in the 35° C. to 42° C. range within 30 minutes after the combining. This convergence window can reduce the duration of any microbial lag phase and may allow downstream detection assays to be performed earlier than in workflows that rely on heated medium alone to raise the temperature of a refrigerated sample.

The process 200 then terminates at an end state 220. In some examples, aliquots of the incubated mixture can be drawn from the fluid-sealed incubation chamber 112 for downstream analysis, including concentration by filtration, centrifugation, or affinity capture, followed by nucleic-acid-based detection, immunochemical detection, or culture-based detection of target pathogens such as Salmonella spp., Escherichia coli (including STEC serotypes), and Listeria spp.

Although the example process depicts a particular sequence of operations, the sequence may be altered without departing from the scope of the present disclosure. For example, some of the operations depicted may be performed in parallel or in a different sequence that does not materially affect the function of the process. In some examples, different components of an example device or system that implements the process may perform functions at substantially the same time or in a specific sequence.

FIG. 3 is a block diagram of a prewarming control architecture 300. As depicted in FIG. 3, the prewarming control architecture 300 includes controller circuitry 302 hosting a proportional-integral-derivative (PID) control loop 304, a temperature sensor 306, a heating element interface 308, a power monitor 310, and a sample mass input 314. The prewarming control architecture 300 further includes a target setpoint 316 (described further below).

The controller circuitry 302 can represent a broad class of control hardware configured to regulate application of thermal energy to a sample of consumable product during prewarming. In some examples, the controller circuitry 302 is configured to receive one or more reference signals, compare those reference signals against one or more feedback signals, and generate a control output that drives a heating element toward convergence on a defined temperature. The controller circuitry 302 can be implemented as a dedicated embedded controller, a programmable logic controller, a system-on-chip, a microcontroller, a field-programmable gate array, an application-specific integrated circuit, or combinations thereof, without departing from the scope of the present disclosure. In some examples, the controller circuitry 302 forms a portion of, or cooperates with, the system controller 114 of FIG. 1.

The target setpoint 316 provides a reference temperature, identified in FIG. 3 as a T2 reference, to the controller circuitry 302. In some examples, the target setpoint 316 corresponds to a second temperature in a range of 20° C. to 37° C., and represents the temperature toward which the sample is to be conditioned during prewarming independently of any enrichment medium. The target setpoint 316 can be supplied as a fixed value, a value retrieved from a lookup table indexed by matrix type, or a value computed based on a difference between a first temperature measured at a time point prior to prewarming and a defined convergence target.

The temperature sensor 306 is thermally associated with the sample or with an ambient region proximate the sample, and produces a feedback signal 312 indicative of a current sample-associated temperature. In some examples, the temperature sensor 306 includes a thermocouple, a resistance temperature detector, a thermistor, or an infrared sensor. The feedback signal 312 may be supplied to the controller circuitry 302 in analog form, in which case the controller circuitry 302 can include an analog-to-digital converter, or in digital form over a serial communications bus such as I2C, SPI, or Modbus.

Within the controller circuitry 302, the PID control loop 304 receives the T2 reference from the target setpoint 316 and the feedback signal 312 from the temperature sensor 306. The PID control loop 304 can be configured to compute a control output that drives an error between the reference and the feedback toward zero. The control output generated by the PID control loop 304 can be supplied to the heating element interface 308 over a control output path. The heating element interface 308 can be configured to translate the control output into an actuation signal for one or more heating elements residing within a prewarming chamber, such as the pre-warming chamber 102 of FIG. 1. In an example, the heating element interface 308 can include a solid-state relay, a pulse-width-modulation driver, a phase-angle controller, a variable-frequency drive, or combinations thereof, and can actuate a forced-air convection element, an infrared emitter, a microwave emitter, a conductive heating plate, or another thermal source discussed with reference to FIG. 5.

In parallel with the control output path, the PID control loop 304 can supply energy consumption data to the power monitor 310. The power monitor 310 can receive a mass value, expressed in kilograms, from the sample mass input 314. In an example, the sample mass input 314 is derived from a load cell integrated into a sample container, such as the sample container 104 of FIG. 1, or can be entered into the controller circuitry 302 via an operator interface at the time the sample is received. The power monitor 310 may be configured to compute a specific energy input attributable to the prewarming operation. In some examples, the controller circuitry 302 can regulate operations according to a threshold, e.g., set at or below about 0.2 kilowatt-hours per kilogram (kWh/kg) of sample, such that the total energy input during prewarming remains below that value.

Interaction among the sensing, control, and monitoring paths may differ depending on the characteristics of the matrix being prewarmed. While a low-thermal-mass sample such as leafy greens may converge on the target setpoint 316 with modest proportional gain applied by the PID control loop 304, a higher-thermal-mass sample such as a composite beef matrix may require a larger integral contribution from the PID control loop 304 to offset heat loss through the matrix. For instance, if the temperature sensor 306 reports a feedback signal 312 of 18° C. against a target setpoint 316 of 25° C. for a leafy-green sample, the PID control loop 304 may generate a moderate control output that brings the sample to within ±0.5° C. of the setpoint within several minutes, while the power monitor 310 records a cumulative specific energy well below the 0.2 kWh/kg threshold. Conversely, for a ground-beef matrix of comparable mass starting at the same feedback signal 312 value, the PID control loop 304 may sustain a higher control output for a longer duration, and the power monitor 310 may intervene to constrain further energy delivery as the specific energy Es approaches the threshold.

In certain deployment scenarios, the prewarming control architecture 300 can be embedded within a laboratory-scale instrument that also houses the pre-warming chamber 102 of FIG. 1 and the enrichment medium reservoir 106 of FIG. 1. In other deployment scenarios, the controller circuitry 302 can reside on a networked edge device that communicates with distributed sensors and heating element interfaces across multiple prewarming stations, allowing a single instance of the PID control loop 304 to be replicated across concurrent sample preparation workflows. Additionally, telemetry from the power monitor 310 can be logged for audit and regulatory-compliance purposes, documenting that prewarming was performed within defined temperature and energy envelopes for each sample processed.

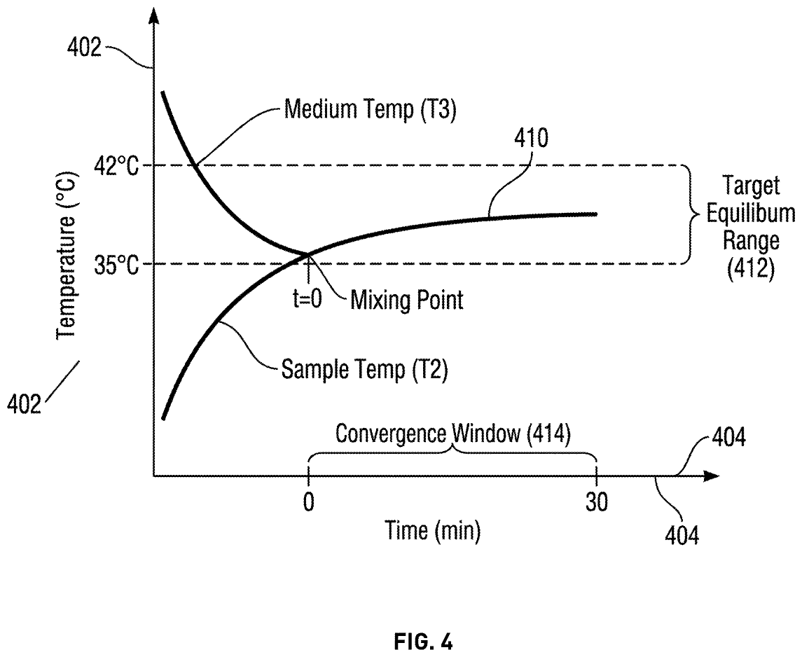

FIG. 4 is a graph of a thermal convergence profile 400. The thermal convergence profile 400 depicts the evolution of temperature over time for two independently conditioned components and for the combined mixture produced therefrom during operation of a sample preparation workflow, such as the method 200 of FIG. 2 implemented using the sample preparation system 100 of FIG. 1. A vertical axis 402 represents temperature, expressed in degrees Celsius, and a horizontal axis 404 represents time, expressed in minutes. A mixing point at t=0 on the horizontal axis 404 corresponds to the instant at which a warmed sample from the sample container 104 of FIG. 1 and a warmed enrichment medium from the enrichment medium reservoir 106 of FIG. 1 are combined within the mixer/homogenizer 110 of FIG. 1.

Prior to the mixing point at t=0, the graph illustrates two temperature trajectories. A sample temperature trajectory labeled T2 represents the temperature of the sample during independent prewarming within the pre-warming chamber 102 of FIG. 1. A medium temperature trajectory 410 labeled T3, depicted as a dashed line, represents the temperature of the enrichment medium during independent prewarming within the enrichment medium reservoir 106 of FIG. 1. The sample temperature T2 approaches the mixing point from below, consistent with a sample that entered the pre-warming chamber 102 at an arrival temperature within the recited 0° C. to 25° C. range (here illustrated, by way of non-limiting example, on the order of 8° C.) and that is being brought toward a second temperature in a range of 20° C. to 37° C. The medium temperature trajectory 410 approaches the mixing point from above, consistent with an enrichment medium that is being actively prewarmed toward a third temperature in a range of 35° C. to 45° C.

At the mixing point t=0, the two trajectories meet within a convergence window 414 bounded on the horizontal axis 404. The convergence window 414 defines a time interval, extending from the mixing point through a duration of up to 30 minutes, during which the combined sample-enrichment medium mixture within the fluid-sealed incubation chamber 112 of FIG. 1 is expected to settle into a target equilibrium range 412. The target equilibrium range 412 is bounded on the vertical axis 402 by a lower value of 35° C. and an upper value of 42° C., and represents the temperature envelope within which the mixture supports proliferation of a target microorganism without exceeding thermal thresholds that may compromise viability of surface-resident organisms.

In an example, the second temperature applied along the sample temperature trajectory T2 and the third temperature applied along the medium temperature trajectory 410 are each selected such that the combined mixture reaches, within ±2° C., a target thermal equilibrium lying within the target equilibrium range 412 before the convergence window 414 elapses. Selection of the second and third temperatures can account for the thermal mass of the sample, the volume and heat capacity of the enrichment medium, the mixing ratio applied by the dispensing assembly 108 of FIG. 1, and the ambient temperature within the fluid-sealed incubation chamber 112 of FIG. 1.

Differentiation between the two independent conditioning paths depicted in FIG. 4 can be illustrated by a representative scenario. For instance, if the sample temperature trajectory T2 terminates at approximately 25° C. at the mixing point and the medium temperature trajectory 410 terminates at approximately 45° C. at the mixing point, a combination performed at a ratio of about 1:1.33 grams of sample per milliliter of medium can yield a mixture that enters the target equilibrium range 412 within approximately 5 minutes following the mixing point. By contrast, a workflow in which a sample at approximately 4° C. is combined directly with an enrichment medium at approximately 45° C. at a comparable ratio can produce an initial mixture temperature below 25° C., and the resulting mixture may remain outside of the target equilibrium range 412 for a duration that extends well beyond the convergence window 414. The arrangement depicted in FIG. 4 therefore enables the mixture to reach the target equilibrium range 412 within the convergence window 414 using reduced volumes of enrichment medium relative to workflows that rely on heated medium alone to offset a refrigerated sample.

Following entry into the target equilibrium range 412, the combined mixture within the fluid-sealed incubation chamber 112 of FIG. 1 may be held at a temperature within the range for a defined incubation duration that supports microbial proliferation. In some deployment scenarios, the incubation duration extends on the order of several hours, and detection aliquots are drawn from the fluid-sealed incubation chamber 112 at defined intervals for downstream analysis. Additionally, the thermal convergence profile 400 can be logged by the system controller 114 of FIG. 1 to produce a per-sample record documenting compliance with a defined convergence specification, supporting auditability across laboratory, mobile, and field-deployment environments.

FIG. 5 illustrates a cross-sectional view of a multimodal prewarming apparatus 500. The multimodal prewarming apparatus 500 can represent one optional embodiment of the pre-warming chamber 102 of FIG. 1, and provides a physical enclosure within which thermal energy is applied to a sample of consumable product from multiple directions and through multiple transfer mechanisms. The apparatus 500 can bring the sample, independently of any enrichment medium, toward a second temperature in a range of 20° C. to 37° C. as specified in connection with the method 200 of FIG. 2, under the regulation of the controller circuitry 302 of FIG. 3.

As depicted in FIG. 5, the multimodal prewarming apparatus 500 includes a chamber housing 502 defining an internal volume, a sample tray 504 disposed within the internal volume, and at least one of a forced-air convection fan 506, an infrared heating element 508, or a microwave emitter 510. The chamber housing 502 can form an outer structural boundary of the apparatus 500. In some examples, the chamber housing 502 can be constructed from a thermally insulating composite, a double-walled stainless steel assembly, or a molded polymer shell lined with reflective foil, and can incorporate an access door or lid to allow loading and unloading of the sample. The internal walls of the chamber housing 502 can, e.g., be finished with a reflective coating to redirect radiant energy toward the sample tray 504 and to reduce heat loss to the ambient environment.

The sample tray 504 can be supported within the chamber housing 502 at a position intermediate between the upper and lower heating modalities. In an example, the sample tray 504 can be fabricated from a perforated stainless steel panel, a wire rack, or a microwave-transparent ceramic platform, and can be sized to accept sample portions ranging from small aliquots to composite samples on the order of one kilogram or more. The sample tray 504 may be removable from the chamber housing 502 to facilitate cleaning and sanitation between processing cycles.

In one example, positioned along an upper interior region of the chamber housing 502, the infrared heating element 508 is oriented toward the sample tray 504 and directs radiant energy downward onto the sample. The infrared heating element 508 may be configured to deliver radiant thermal energy across a defined wavelength band toward the sample tray 504. In some examples, the infrared heating element 508 includes a quartz-tube emitter, a ceramic panel emitter, or a carbon-fiber emitter operating in a near-infrared or medium-infrared band. The radiant output of the infrared heating element 508 can be modulated by the heating element interface 308 of FIG. 3 in response to a control output from the PID control loop 304 of FIG. 3.

In another example, alternatively or additionally to the infrared heating element 508, the prewarming apparatus can include or use a microwave emitter 510 that is arranged along a sidewall of the chamber housing 502 and directs microwave radiation toward the sample tray 504. The microwave emitter 510 may include a magnetron, a solid-state microwave generator, or a combination thereof, coupled to the internal volume of the chamber housing 502 via a waveguide or slot antenna. In some examples, the microwave emitter 510 operates at a frequency within a range of about 1 gigahertz (GHz) to about 100 GHz, (e.g., at or near a frequency of about 2.45 GHz) and delivers volumetric heating throughout the thickness of the sample residing on the sample tray 504, complementing the surface-oriented radiant heating delivered by the infrared heating element 508.

In yet another example, alternatively or additionally to either of the infrared heating element 508 or the microwave emitter 510, the prewarming apparatus 500 can include a forced-air convection fan 506, disposed along a lateral boundary of the chamber housing 502 and arranged to establish a circulating airflow within the internal volume. The forced-air convection fan 506 can be configured to drive heated air across the infrared heating element 508 and along the sample tray 504. In some examples, the forced-air convection fan 506 is implemented as an axial fan, a cross-flow blower, or a centrifugal fan, and cooperates with an auxiliary resistive heating coil positioned in its airflow path to produce a uniform convective boundary layer around the sample.

In an example, the prewarming apparatus can include or use a combination of the infrared heating element 508, the microwave emitter 510, or the convection fan 506. Differentiation among the three heating modalities enables the multimodal prewarming apparatus 500 to adapt to a range of matrix types. While the forced-air convection fan 506 may be well suited to leafy-green matrices, where surface-oriented heat transfer across exposed leaf surfaces dominates, the microwave emitter 510 may be preferable for dense or high-fat matrices such as ground beef, where volumetric heating penetrates the interior of the matrix. For instance, if the sample tray 504 carries a ~1,500 g leafy-green sample at an initial temperature of about 8 °C and a target setpoint of about 25° C. is supplied to the controller circuitry 302 of FIG. 3, the forced-air convection fan 506 and the infrared heating element 508 can operate in combination (e.g., concurrently) such that they drive the sample toward the setpoint without appreciable activation of the microwave emitter 510. Conversely, if the sample tray 504 carries a ~1,500 g ground-beef sample at the same initial temperature and the same setpoint, the controller circuitry 302 of FIG. 3 can engage the microwave emitter 510 concurrent with the forced-air convection fan 506, such as to reduce the time required for the interior of the matrix to approach the setpoint.

In certain deployment scenarios, the multimodal prewarming apparatus 500 can be integrated into a benchtop sample-preparation instrument alongside the enrichment medium reservoir 106 of FIG. 1 and the fluid-sealed incubation chamber 112 of FIG. 1. In other deployment scenarios, the apparatus 500 can be provisioned as a standalone conditioning module located near a sample-receiving station, with its operation coordinated over a local network by the system controller 114 of FIG. 1. Additionally, thermal telemetry generated during operation of the apparatus 500 can be relayed to a cloud-based data store for longitudinal monitoring of prewarming performance across distributed testing facilities.

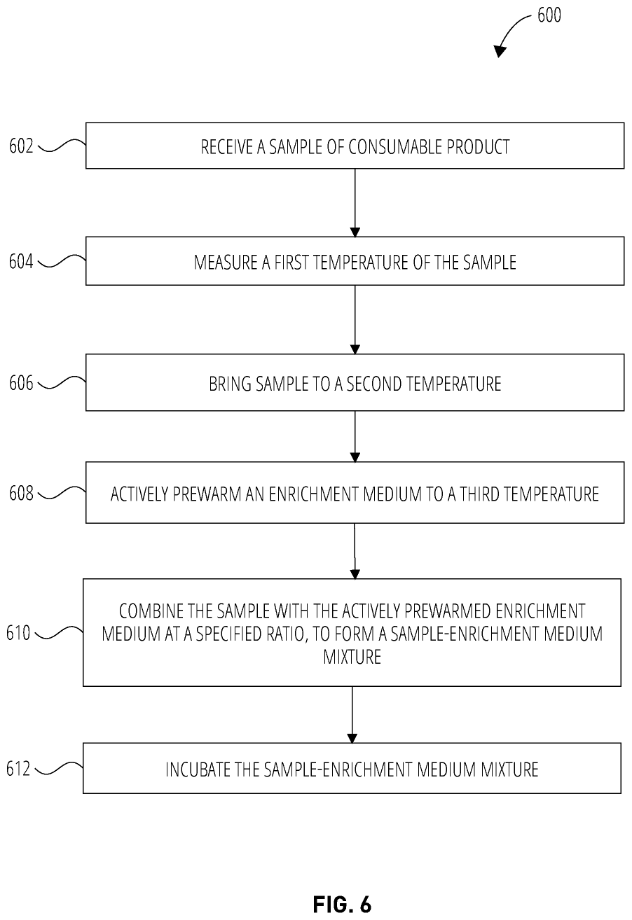

FIG. 6 is a flowchart illustrating a process 600 of preparing a sample of consumable product for pathogen detection, according to some examples. The process 600 may be carried out using the system 100 of FIG. 1, including the pre-warming chamber 102 of FIG. 1, the enrichment medium reservoir 106 of FIG. 1, the dispensing assembly 108 of FIG. 1, the mixer/homogenizer 110 of FIG. 1, the fluid-sealed incubation chamber 112 of FIG. 1, and the system controller 114 of FIG. 1, with thermal regulation supplied by the controller circuitry 302 of FIG. 3. The process 600 includes operations 602, 604, 606, 608, 610, and 612, which are described sequentially below. Although FIG. 6 depicts the operations in a particular order, certain operations may be reordered, combined, performed in parallel, or omitted in various examples.

At operation 602, a sample of consumable product is received. The sample may be received at a sample receiving unit of the system 100 of FIG. 1 and deposited into the sample container 104 of FIG. 1. The sample of consumable product may arrive at the sample receiving unit following a refrigeration interval at an ambient temperature below about 8° C., such as during a cold-chain transport segment from a point of collection to a point of testing. In an example, the sample is a solid food sample, such as leafy greens, ground meat, poultry trim, seafood fillet, ready-to-eat meal portion, dairy cheese, or produce composite, e.g., at a by-volume weight within a range of about 500 g to about 2000 g (e.g., such as a weight of about 1,500 g). The sample can also include a liquid food or beverage sample, such as milk, juice, process water, or a rinse collected from a carcass or food-contact surface. The operation 602 establishes the sample within a defined thermal boundary that the pre-warming chamber 102 of FIG. 1 can control during subsequent operations.

At operation 604, a first temperature of the sample is measured. In an example, the temperature sensor 306 of FIG. 3 thermally associated with the sample container 104 of FIG. 1 reports the first temperature to the controller circuitry 302 of FIG. 3 via the feedback signal 312 of FIG. 3. In an example, the temperature sensor 306 of FIG. 3 is implemented as a thermocouple probe inserted into the sample matrix, a resistance temperature detector (RTD) embedded in the wall of the sample container 104 of FIG. 1, a thermistor array distributed along interior and exterior positions of the sample, or a non-contact infrared sensor directed at the sample surface. The first temperature can serve as an initial condition against which the controller circuitry 302 of FIG. 3 computes an initial error signal relative to the target setpoint 316 of FIG. 3, and can also be logged for documentation of sample arrival conditions. The operation 604 can provide the closed-loop control architecture with a reference point from which to regulate the subsequent thermal transition.

At operation 606, the sample can be brought to a second temperature. The second temperature can be within a range of about 20° C. to about 37° C. and can be reached by conditioning the sample independently of any enrichment medium. In an example, the operation 606 can be carried out by actively prewarming the sample within the pre-warming chamber 102 of FIG. 1, which can be implemented as the multimodal prewarming apparatus 500 of FIG. 5. Here, e.g., the controller circuitry 302 of FIG. 3 can execute the PID control loop 304 of FIG. 3 against the target setpoint 316 of FIG. 3 which modulates power delivered through the heating element interface 308 of FIG. 3 to one or more heating modalities, including the forced-air convection fan 506 of FIG. 5, the infrared heating element 508 of FIG. 5, and the microwave emitter 510 of FIG. 5. In an example, cumulative energy delivered during the operation 606 is tracked by the power monitor 310 of FIG. 3 in conjunction with the sample mass input 314 of FIG. 3, which can optionally be constrained to less than 0.2 kWh/kg of sample. In alternative implementations, the operation 606 can be carried out via passive heating of the sample toward an ambient air temperature within a temperate laboratory environment, or through a continuous-flow configuration in which a slurry of the sample circulates through an inline heater until the second temperature is reached. The operation 606 places the sample within a thermal band that sits above refrigeration conditions and below thresholds that may compromise viability of target microorganisms residing on sample surfaces.

At operation 608, an enrichment medium is actively prewarmed to a third temperature. The third temperature lies within a range of 35° C. to 45° C. The enrichment medium reservoir 106 of FIG. 1 contains an enrichment medium selected according to the target pathogen and matrix, such as buffered peptone water, Rappaport-Vassiliadis soy peptone broth, tetrathionate broth, selenite cystine broth, University of Vermont medium I or II, Fraser broth, modified tryptone soya broth with novobiocin or selective supplements, Bolton broth, Preston broth, or Campy-Thio broth. In an example, the enrichment medium reservoir 106 of FIG. 1 includes a resistive heating jacket, a water-bath immersion coil, a Peltier thermoelectric assembly, or an inline preheater positioned along a supply line to the dispensing assembly 108 of FIG. 1. A dedicated medium-side temperature sensor may report a medium feedback signal to the system controller 114 of FIG. 1, which can regulate the medium temperature against a medium-side setpoint via a separate PID loop. In an example, the operation 608 proceeds in parallel with the operation 606, such that the sample and the medium approach their respective target temperatures over overlapping intervals. The operation 608 establishes the second thermal mass within the thermal band selected to complete convergence to the target thermal equilibrium upon combination.

At operation 610, the sample is combined with the actively prewarmed enrichment medium at a specified ratio to form a sample-enrichment medium mixture. The operation 610 occurs after the sample reaches the second temperature, as determined by comparison of the feedback signal 312 of FIG. 3 against the target setpoint 316 of FIG. 3. The dispensing assembly 108 of FIG. 1 transfers a volume of the prewarmed enrichment medium from the enrichment medium reservoir 106 of FIG. 1 into the mixer/homogenizer 110 of FIG. 1 together with the prewarmed sample from the sample container 104 of FIG. 1 at a ratio within a range of 1:1 to 1:6 grams per milliliter (g/mL) of sample to enrichment medium. In an example, the dispensing assembly 108 of FIG. 1 includes a peristaltic pump, a gravity-fed valve assembly, a syringe-pump dispenser, or a volumetric batching vessel calibrated against the sample mass input 314 of FIG. 3. The combining may include homogenizing the sample and the enrichment medium using the mixer/homogenizer 110 of FIG. 1, which may be implemented as a paddle-blender, a peristaltic stomacher, a rotary impeller mixer, or a tumbling vessel, prior to the subsequent incubation. The selection of the second temperature and the third temperature is coordinated such that the sample-enrichment medium mixture reaches, within ±2° C., a target thermal equilibrium within a range of 35° C. to 42° C., within 30 minutes after the operation 610, consistent with the thermal convergence profile 400 of FIG. 4. The operation 610 produces a combined thermal mass positioned at or near the microbial growth band without reliance on an extended exponential decay toward that band.

At operation 612, the sample-enrichment medium mixture is incubated. The mixture is transferred into the fluid-sealed incubation chamber 112 of FIG. 1, and the chamber maintains the mixture at an ambient temperature within a range of 35° C. to 42° C. for an incubation duration selected in accordance with the target pathogen and the matrix. In an example, the fluid-sealed incubation chamber 112 of FIG. 1 includes a gasketed lid, a septum port for aliquot withdrawal, and an internal temperature sensor reporting to the system controller 114 of FIG. 1. The incubation duration may be on the order of six hours for certain matrix and target combinations, including leafy-green samples assayed for Escherichia coli STEC and Salmonella spp., and may be extended or shortened for other combinations based on size, volume, density, porosity, type, material content, proclivity to pathogens, source of the sample, or applicable regulatory requirements. In an example, following the operation 612, an aliquot of the incubated mixture is withdrawn and analyzed using a nucleic-acid-based assay, an immunochemical assay, a target amplification assay, a bacteriophage-based assay, or a culture-based confirmation procedure. The operation 612 permits proliferation of target microorganisms within a controlled thermal and fluidic environment, yielding a culture suitable for downstream detection.

In an example, the process 600 further includes monitoring operations executed concurrently with one or more of the operations 602 through 612. The system controller 114 of FIG. 1 may log temperature telemetry from the temperature sensor 306 of FIG. 3, energy telemetry from the power monitor 310 of FIG. 3, and timing data corresponding to the convergence window 414 of FIG. 4. The logged telemetry may be transmitted over a network interface to a laboratory information management system, a cloud-based data store, or a regulatory compliance archive, producing an auditable record of sample handling.

In an example, the process 600 is implemented as instructions stored on a non-transitory computer-readable medium that, when executed by one or more processors associated with the system controller 114 of FIG. 1, cause the one or more processors to perform the operations 602 through 612. The instructions may coordinate the operations 606 and 608 in parallel, may enforce an energy cap of 0.2 kWh/kg during the operation 606, may constrain the dispensing performed during the operation 610 to a ratio within the 1:1 to 1:6 g/mL range, and may condition entry into the operation 612 on confirmation by the temperature sensor 306 of FIG. 3 that the sample has reached the second temperature and on confirmation by a medium-side temperature sensor that the medium has reached the third temperature.

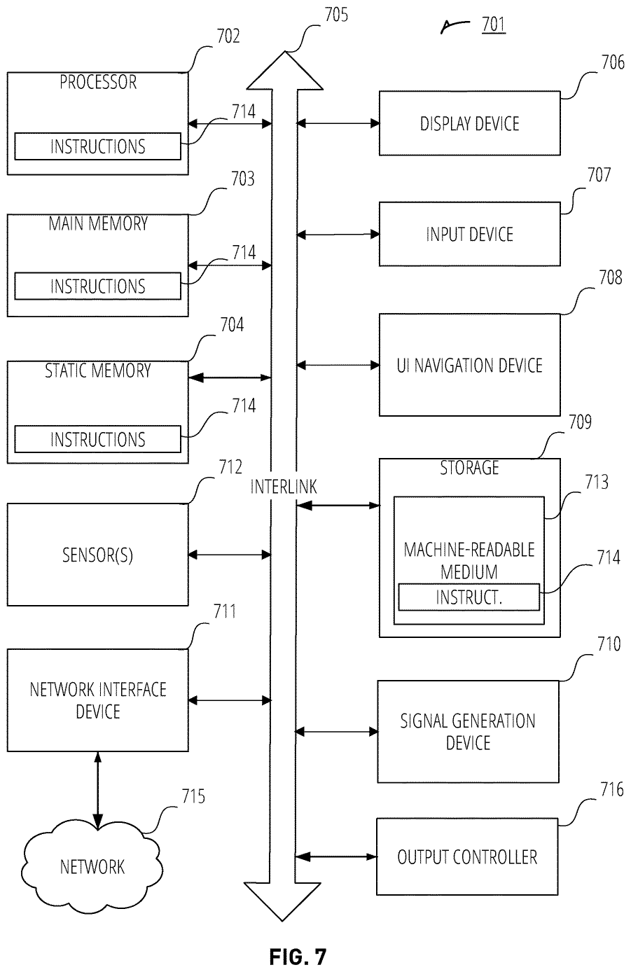

FIG. 7 illustrates generally an example of a block diagram of a machine 701 upon which any one or more of the techniques (e.g., methodologies) discussed herein may be performed in accordance with some examples. In alternative embodiments, the machine 701 may operate as a standalone device or may be connected (e.g., networked) to other machines. In a networked deployment, the machine 701 may operate in the capacity of a server machine, a client machine, or both in server-client network environments. In an example, the machine 701 may act as a peer machine in peer-to-peer (P2P) (or other distributed) network environments. The machine 701 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer-readable medium containing instructions, where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 701 may include a hardware processor 702 (e.g., a central processing unit (CPU), a graphics processing unit (GPU), a hardware processor core, or any combination thereof), a main memory 703 and a static memory 704, some or all of which may communicate with each other via an interlink (e.g., bus) 705. The machine 701 may further include a display unit 706, an alphanumeric input device 707 (e.g., a keyboard), and a user interface (UI) navigation device 708 (e.g., a mouse). In an example, the display unit 706, alphanumeric input device 707, and UI navigation device 708 may be a touch screen display. The machine 701 may additionally include a storage device (e.g., drive unit) 709, a signal generation device 710 (e.g., a speaker), a network interface device 711, and one or more sensors 712, such as a global positioning system (GPS) sensor, compass, accelerometer, or other sensor. The machine 701 may include an output controller 716, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 709 may include a machine-readable medium 713 that is non-transitory on which is stored one or more sets of data structures or instructions 714 (e.g., software) embodying or utilized by any one or more of the techniques or functions described herein. The instructions 714 may also reside, completely or at least partially, within the main memory 703, within static memory 704, or within the hardware processor 702 during execution thereof by the machine 701. In an example, one or any combination of the hardware processor 702, the main memory 703, the static memory 704, or the storage device 709 may constitute machine-readable media.

While the machine-readable medium 713 is illustrated as a single medium, the term “machine-readable medium” may include a single medium or multiple media (e.g., a centralized or distributed database, or associated caches and servers) configured to store the one or more instructions 714.

The term “machine-readable medium” may include any medium that is capable of storing, encoding, or carrying instructions for execution by the machine 701 and that cause the machine 701 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 714 may further be transmitted or received over a communications network 715 using a transmission medium via the network interface device 711 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 711 may include one or more physical jacks (e.g., Ethernet, coaxial, or phone jacks) or one or more antennas to connect to the communications network 715. In an example, the network interface device 711 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 701, and includes digital or analog communications signals or other intangible medium to facilitate communication of such software.

The following, non-limiting examples, detail certain aspects of the present subject matter to solve the challenges and provide the benefits discussed herein, among others.

Example 1 is a method of preparing a sample of consumable product for pathogen detection, the method comprising: receiving the sample of consumable product, at an arrival temperature within a range of 0° C. to 25° C., the arrival temperature being independent of any prior refrigeration of the sample; measuring a first temperature of the sample; bringing the sample, independently of any enrichment medium, to a second temperature in a range of 20° C. to 37 °C; actively prewarming an enrichment medium to a third temperature in a range of 35 °C to 45° C.; combining, after the sample reaches the second temperature, the sample with the actively prewarmed enrichment medium at a ratio within a range of 1:1 to 1:6 grams per milliliter (g/mL) sample to enrichment medium, to form a sample-enrichment medium mixture; and incubating, within a fluid-sealed incubation chamber, the sample-enrichment medium mixture at an ambient temperature within a range of 35° C. to 42° C.; wherein the second temperature and the third temperature are each selected such that the sample-enrichment medium mixture reaches, within ±2° C., a target thermal equilibrium, the target thermal equilibrium being within a range of 35° C. to 42° C. , within 30 minutes after combining the sample with the actively prewarmed enrichment medium.

Example 2 is the method of Example 1, wherein bringing the sample to the second temperature includes actively prewarming the sample in a temperature-controlled prewarming chamber.

Example 3 is the method according to any one or more of Examples 1-2, comprising regulating, via controller circuitry, the actively prewarmed sample based on received feedback from a temperature sensor thermally associated with the sample.

Example 4 is the method according to any one or more of Examples 1-3, wherein regulation includes performing, via the controller circuitry, a proportional-integral-derivative (PID) loop.

Example 5 is the method according to any one or more of Examples 1-4, wherein the actively prewarming the sample includes applying at least one of forced-air, heat via convection, infrared heating, or microwave heating in the prewarming chamber.

Example 6 is the method according to any one or more of Examples 1-5, wherein a total energy input during actively prewarming the sample remains less than 0.2 kWh/kg of sample.

Example 7 is the method according to any one or more of Examples 1-6, wherein bringing the sample to the second temperature includes passively heating the sample toward an ambient air temperature.

Example 8 is the method according to any one or more of Examples 1-7, wherein the combining includes homogenizing, via a mixer or blender, the sample and enrichment medium prior to the incubation of the sample-enrichment medium mixture.

Example 9 is the method according to any one or more of Examples 1-8, wherein the sample of consumable product includes a solid food sample.

Example 10 is the method according to any one or more of Examples 1-9, wherein the sample of consumable product is a liquid food or beverage sample.

Example 11 is the method according to any one or more of Examples 1-10, wherein the arrival temperature is within a range of 0° C. to 10° C.

Example 12 is the method according to any one or more of Examples 1-11, wherein the arrival temperature is at or above 15° C.

Example 13 is the method according to any one or more of Examples 1-12, wherein the sample is received without a controlled cold chain between collection and receipt, such that the arrival temperature reflects uncontrolled ambient exposure.

Example 14 is the method according to any one or more of Examples 1-13, wherein the sample-enrichment medium mixture reaches the target thermal equilibrium within 15 minutes after the combining.

Example 15 is a system for preparing a sample of consumable product for pathogen detection, the system comprising: a sample receiving unit configured to receive the sample of consumable product at an arrival temperature within a range of 0° C. to 25° C., the arrival temperature being independent of any prior refrigeration of the sample; a temperature sensor configured to measure a first temperature of the sample; a prewarming unit configured to bring the sample, independently of any enrichment medium, to a second temperature in a range of 20° C. to 37° C.; an enrichment medium reservoir configured to actively prewarm an enrichment medium to a third temperature in a range of 35° C. to 45° C.; a dispensing assembly configured to combine, after the sample reaches the second temperature, the sample with the actively prewarmed enrichment medium at a ratio within a range of 1:1 to 1:6 grams per milliliter (g/mL) of sample to enrichment medium, to form a sample-enrichment medium mixture; and a fluid-sealed incubation chamber configured to incubate the sample-enrichment medium mixture at an ambient temperature within a range of 35° C. to 42° C.; wherein the second temperature and the third temperature are each selected such that the sample-enrichment medium mixture reaches, within ±2° C., a target thermal equilibrium, the target thermal equilibrium being within a range of 35 °C to 42° C., within 30 minutes after the sample is combined with the actively prewarmed enrichment medium.

Example 16 is the system of Example 15, wherein the prewarming unit comprises a temperature-controlled prewarming chamber configured to actively prewarm the sample.

Example 17 is the system according to any one or more of Examples 15-16, further comprising controller circuitry configured to regulate the actively prewarmed sample based on received feedback from the temperature sensor thermally associated with the sample.

Example 18 is the system according to any one or more of Examples 15-17, wherein the controller circuitry is configured to perform a proportional-integral-derivative (PID) loop.

Example 19 is the system according to any one or more of Examples 15-18, wherein the prewarming chamber is configured to apply at least one of forced-air, heat via convection, infrared heating, or microwave heating to the sample.

Example 20 is the system according to any one or more of Examples 15-19, wherein the prewarming unit is configured to bring the sample to the second temperature by passively heating the sample toward an ambient air temperature.

Example 21 is the system according to any one or more of Examples 15-20, further comprising a mixer or blender configured to homogenize the sample and the enrichment medium prior to incubation of the sample-enrichment medium mixture in the fluid-sealed incubation chamber.

Example 22 is the system according to any one or more of Examples 15-21, wherein the arrival temperature is within a range of 0° C. to 10° C.

Example 23 is the system according to any one or more of Examples 15-22, wherein the arrival temperature is at or above 15° C.

Example 24 is the system according to any one or more of Examples 15-23, wherein the sample receiving unit is configured to receive the sample without a controlled cold chain between collection and receipt, such that the arrival temperature reflects uncontrolled ambient exposure.

Example 25 is the system according to any one or more of Examples 15-24, wherein the second temperature and the third temperature are selected such that the sample-enrichment medium mixture reaches the target thermal equilibrium within 15 minutes after the sample is combined with the actively prewarmed enrichment medium.

Example 26 is a non-transitory computer-readable medium storing instructions that, when executed by one or more processors, cause the one or more processors to perform operations for preparing a sample of consumable product for pathogen detection, the operations comprising: receiving an indication that the sample of consumable product has been received at an arrival temperature within a range of 0° C. to 25° C., the arrival temperature being independent of any prior refrigeration of the sample; receiving, from a temperature sensor, a first temperature of the sample; causing a prewarming unit to bring the sample, independently of any enrichment medium, to a second temperature in a range of 20° C. to 37° C.; triggering an enrichment medium reservoir to actively prewarm an enrichment medium to a third temperature in a range of 35° C. to 45° C.; triggering, after the sample reaches the second temperature, a dispensing assembly to combine the sample with the actively prewarmed enrichment medium at a ratio within a range of 1:1 to 1:6 grams per milliliter (g/mL) of sample to enrichment medium, to form a sample-enrichment medium mixture; and controlling ambient conditions within a fluid-sealed incubation chamber, to incubate the sample-enrichment medium mixture at an ambient temperature within a range of 35° C. to 42° C.; wherein the second temperature and the third temperature are each selected such that the sample-enrichment medium mixture reaches, within ±2° C., a target thermal equilibrium, the target thermal equilibrium being within a range of 35° C. to 42° C., within 30 minutes after the sample is combined with the actively prewarmed enrichment medium.

Example 27 is the non-transitory computer-readable medium of Example 26, wherein the triggering the prewarming unit to bring the sample to the second temperature comprises causing a temperature-controlled prewarming chamber to actively prewarm the sample.

Example 28 is the non-transitory computer-readable medium according to any one or more of Examples 26-27, wherein the operations further comprise regulating the actively prewarmed sample based on received feedback from the temperature sensor thermally associated with the sample.

Example 29 is the non-transitory computer-readable medium according to any one or more of Examples 26-28, wherein the regulating comprises executing a proportional-integral-derivative (PID) loop.

Example 30 is the non-transitory computer-readable medium according to any one or more of Examples 26-29, wherein the triggering the prewarming chamber to actively prewarm the sample comprises causing application of at least one of forced-air, heat via convection, infrared heating, or microwave heating in the prewarming chamber.

Example 31 is the non-transitory computer-readable medium according to any one or more of Examples 26-30, wherein the operations further comprise constraining a total energy input during the actively prewarming of the sample to less than 0.2 kWh/kg of sample.

Example 32 is the non-transitory computer-readable medium according to any one or more of Examples 26-31, wherein the arrival temperature is within a range of 0° C. to 10° C.

Example 33 is the non-transitory computer-readable medium according to any one or more of Examples 26-32, wherein the arrival temperature is at or above 15° C.

Example 34 is the non-transitory computer-readable medium according to any one or more of Examples 26-33, wherein the operations further comprise receiving the sample without a controlled cold chain between collection and receipt, such that the arrival temperature reflects uncontrolled ambient exposure.

Example 35 is the non-transitory computer-readable medium according to any one or more of Examples 26-34, wherein the sample-enrichment medium mixture reaches the target thermal equilibrium within 15 minutes after the sample is combined with the actively prewarmed enrichment medium.

The above Detailed Description can include references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of preparing a sample of consumable product for pathogen detection, the method comprising:
receiving the sample of consumable product, at an arrival temperature within a range of 0° C. to 25° C., the arrival temperature being independent of any prior refrigeration of the sample;
measuring a first temperature of the sample;
bringing the sample, independently of any enrichment medium, to a second temperature in a range of 20° C. to 37° C.;
actively prewarming an enrichment medium to a third temperature in a range of 35° C. to 45° C.;
combining, after the sample reaches the second temperature, the sample with the actively prewarmed enrichment medium at a ratio within a range of 1:1 to 1:6 grams per milliliter (g/mL) sample to enrichment medium, to form a sample-enrichment medium mixture; and
incubating, within a fluid-sealed incubation chamber, the sample-enrichment medium mixture at an ambient temperature within a range of 35° C. to 42° C.;
wherein the second temperature and the third temperature are each selected such that the sample-enrichment medium mixture reaches, within ±2° C., a target thermal equilibrium, the target thermal equilibrium being within a range of 35° C. to 42° C., within 30 minutes after combining the sample with the actively prewarmed enrichment medium.

2. The method of claim 1, wherein bringing the sample to the second temperature includes actively prewarming the sample in a temperature-controlled prewarming chamber.

3. The method of claim 2, comprising regulating, via controller circuitry, the actively prewarmed sample based on received feedback from a temperature sensor thermally associated with the sample.

4. The method of claim 3, wherein regulation includes performing, via the controller circuitry, a proportional-integral-derivative (PID) loop.

5. The method of claim 2, wherein the actively prewarming the sample includes applying at least one of forced-air, heat via convection, infrared heating, or microwave heating in the prewarming chamber.

6. The method of claim 2, wherein a total energy input during actively prewarming the sample remains less than 0.2 kWh/kg of sample.

7. The method of claim 1, wherein bringing the sample to the second temperature includes passively heating the sample toward an ambient air temperature.

8. The method of claim 1, wherein the combining includes homogenizing, via a mixer or blender, the sample and enrichment medium prior to the incubation of the sample-enrichment medium mixture.

9. The method of claim 1, wherein the sample of consumable product includes a solid food sample.

10. The method of claim 1, wherein the sample of consumable product is a liquid food or beverage sample.

11. The method of claim 1, wherein the arrival temperature is within a range of 0° C. to 10° C.

12. The method of claim 1, wherein the arrival temperature is at or above 15° C.

13. The method of claim 1, wherein the sample is received without a controlled cold chain between collection and receipt, such that the arrival temperature reflects uncontrolled ambient exposure.

14. The method of claim 1, wherein the sample-enrichment medium mixture reaches the target thermal equilibrium within 15 minutes after the combining.

15. A system for preparing a sample of consumable product for pathogen detection, the system comprising:
a sample receiving unit configured to receive the sample of consumable product at an arrival temperature within a range of 0° C. to 25° C., the arrival temperature being independent of any prior refrigeration of the sample;
a temperature sensor configured to measure a first temperature of the sample;
a prewarming unit configured to bring the sample, independently of any enrichment medium, to a second temperature in a range of 20° C. to 37° C.;
an enrichment medium reservoir configured to actively prewarm an enrichment medium to a third temperature in a range of 35° C. to 45° C.;
a dispensing assembly configured to combine, after the sample reaches the second temperature, the sample with the actively prewarmed enrichment medium at a ratio within a range of 1:1 to 1:6 grams per milliliter (g/mL) of sample to enrichment medium, to form a sample-enrichment medium mixture; and
a fluid-sealed incubation chamber configured to incubate the sample-enrichment medium mixture at an ambient temperature within a range of 35° C. to 42° C.;
wherein the second temperature and the third temperature are each selected such that the sample-enrichment medium mixture reaches, within ±2 ° C., a target thermal equilibrium, the target thermal equilibrium being within a range of 35° C. to 42° C., within 30 minutes after the sample is combined with the actively prewarmed enrichment medium.

16. The system of claim 15, wherein the prewarming unit comprises a temperature-controlled prewarming chamber configured to actively prewarm the sample.

17. The system of claim 16, further comprising controller circuitry configured to regulate the actively prewarmed sample based on received feedback from the temperature sensor thermally associated with the sample.

18. The system of claim 17, wherein the controller circuitry is configured to perform a proportional-integral-derivative (PID) loop.

19. The system of claim 16, wherein the prewarming chamber is configured to apply at least one of forced-air, heat via convection, infrared heating, or microwave heating to the sample.

20. The system of claim 15, wherein the prewarming unit is configured to bring the sample to the second temperature by passively heating the sample toward an ambient air temperature.

21. The system of claim 15, further comprising a mixer or blender configured to homogenize the sample and the enrichment medium prior to incubation of the sample-enrichment medium mixture in the fluid-sealed incubation chamber.

22. The system of claim 15, wherein the arrival temperature is within a range of 0° C. to 10° C.

23. The system of claim 15, wherein the arrival temperature is at or above 15° C.

24. The system of claim 15, wherein the sample receiving unit is configured to receive the sample without a controlled cold chain between collection and receipt, such that the arrival temperature reflects uncontrolled ambient exposure.

25. The system of claim 15, wherein the second temperature and the third temperature are selected such that the sample-enrichment medium mixture reaches the target thermal equilibrium within 15 minutes after the sample is combined with the actively prewarmed enrichment medium.

26. A non-transitory computer-readable medium storing instructions that, when executed by one or more processors, cause the one or more processors to perform operations for preparing a sample of consumable product for pathogen detection, the operations comprising:
receiving an indication that the sample of consumable product has been received at an arrival temperature within a range of 0° C. to 25° C., the arrival temperature being independent of any prior refrigeration of the sample;
receiving, from a temperature sensor, a first temperature of the sample; causing a prewarming unit to bring the sample, independently of any enrichment medium, to a second temperature in a range of 20° C. to 37° C.;
triggering an enrichment medium reservoir to actively prewarm an enrichment medium to a third temperature in a range of 35° C. to 45° C.;
triggering, after the sample reaches the second temperature, a dispensing assembly to combine the sample with the actively prewarmed enrichment medium at a ratio within a range of 1:1 to 1:6 grams per milliliter (g/mL) of sample to enrichment medium, to form a sample-enrichment medium mixture;
and controlling ambient conditions within a fluid-sealed incubation chamber, to incubate the sample-enrichment medium mixture at an ambient temperature within a range of 35° C. to 42° C.;
wherein the second temperature and the third temperature are each selected such that the sample-enrichment medium mixture reaches, within ±2° C., a target thermal equilibrium, the target thermal equilibrium being within a range of 35° C. to 42° C., within 30 minutes after the sample is combined with the actively prewarmed enrichment medium.

27. The non-transitory computer-readable medium of claim 26, wherein the triggering the prewarming unit to bring the sample to the second temperature comprises causing a temperature-controlled prewarming chamber to actively prewarm the sample.

28. The non-transitory computer-readable medium of claim 27, wherein the operations further comprise regulating the actively prewarmed sample based on received feedback from the temperature sensor thermally associated with the sample.

29. The non-transitory computer-readable medium of claim 28, wherein the regulating comprises executing a proportional-integral-derivative (PID) loop.

30. The non-transitory computer-readable medium of claim 27, wherein the triggering the prewarming chamber to actively prewarm the sample comprises causing application of at least one of forced-air, heat via convection, infrared heating, or microwave heating in the prewarming chamber.

31. The non-transitory computer-readable medium of claim 27, wherein the operations further comprise constraining a total energy input during the actively prewarming of the sample to less than 0.2 kWh/kg of sample.

32. The non-transitory computer-readable medium of claim 26, wherein the arrival temperature is within a range of 0° C. to 10° C.

33. The non-transitory computer-readable medium of claim 26, wherein the arrival temperature is at or above 15° C.

34. The non-transitory computer-readable medium of claim 26, wherein the operations further comprise receiving the sample without a controlled cold chain between collection and receipt, such that the arrival temperature reflects uncontrolled ambient exposure.

35. The non-transitory computer-readable medium of claim 26, wherein the sample-enrichment medium mixture reaches the target thermal equilibrium within 15 minutes after the sample is combined with the actively prewarmed enrichment medium.
